(19) United States
(12) Patent Application Publication
(10) Pub. No.: US 2025/0232895 A1
(43) Pub. Date: Jul. 17, 2025

(54) ELECTRIC CABLE WITH UNDULATED TUBING SEGMENTS FOR SUSPENSION IN A WELL SYSTEM AND METHOD OF ASSEMBLY THEREOF

(71) Applicant: Halliburton Energy Service, Inc, Houston, TX (US)

(72) Inventor: Terry Glasscock, Tulsa, OK (US)

(21) Appl. No.: 18/410,864

(22) Filed: Jan. 11, 2024

(51) Int. Cl. H01B 7/20; E21B 17/00; H01B 7/18; H01B 13/22

(52) U.S. Cl. CPC H01B 7/204; E21B 17/003; H01B 7/1875; H01B 13/228

(57) ABSTRACT

An electric cable for powering a downhole tool in a wellbore. The electric cable includes a core including one or more electrically conductive wires and one or more electric insulating layers surrounding the conductive wires; a metal inner tube surrounding the core, where the metal inner tubing and the core includes one or more undulated segments with one or more curved outer extensions projecting outwards from a longitudinal axis of the electric cable; and an outer encapsulating tube surrounding the core and metal inner tube, where the outer surface of the metal inner tube has outermost portions at the curved outer extensions of the undulated segments that touch an inner surface of the outer encapsulating tube. A well system including the electric cable and a method of assembling the electric cable are also disclosed.

### TECHNICAL FIELD

This application is directed, in general, to an electric cable for use in a well system for subterranean wells or for drilling operations for creating a wellbore, and, more specifically, to electric cables with undulated tubing segments for suspending the tubing within an outer encapsulating tube and methods of assembling thereof.

### BACKGROUND

Electric cables can be used to provide electrical power to downhole tools in well systems. Often the core of the electric cable, the core including an electrical conductive wire wrapped in electrical insulation, is placed inside of a metal inner tube and outer encapsulating tube, e.g., to help protect the core from harsh downhole mechanical, chemical, pressure and temperature environments. When vertically positioned in a wellbore, the cable can be coupled to a splice to another cable or a connector of the downhole tool. For long lengths, the weight of the electric cable increases the amount of strain on the splices or connector to thereby increase the risk of mechanical failure.

### BRIEF DESCRIPTION

Reference is now made to the following descriptions taken in conjunction with the accompanying drawings, in which:

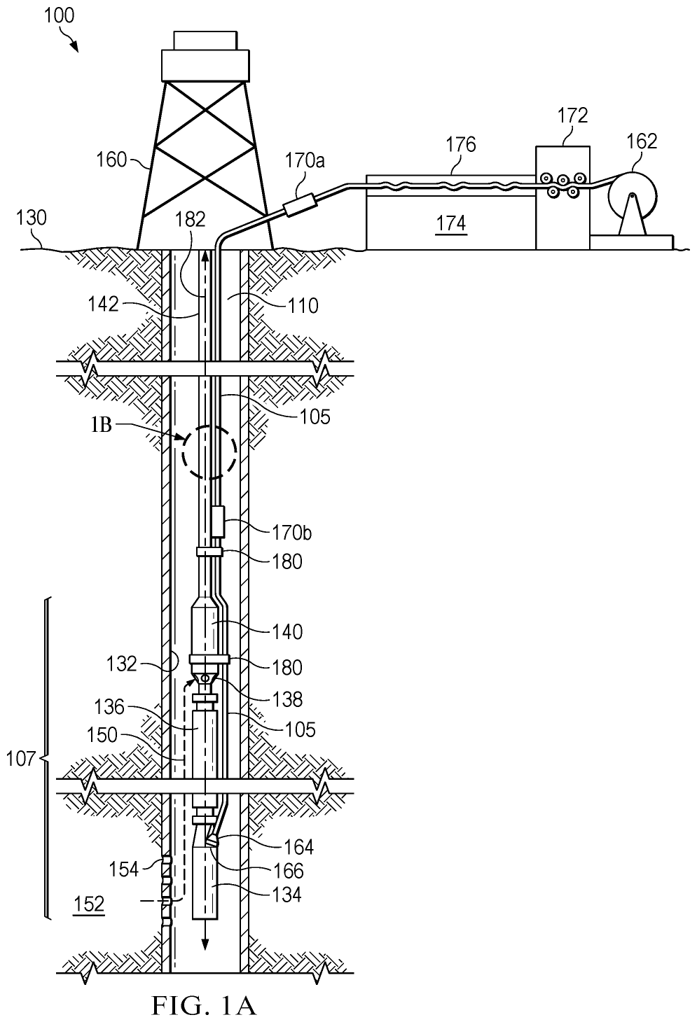

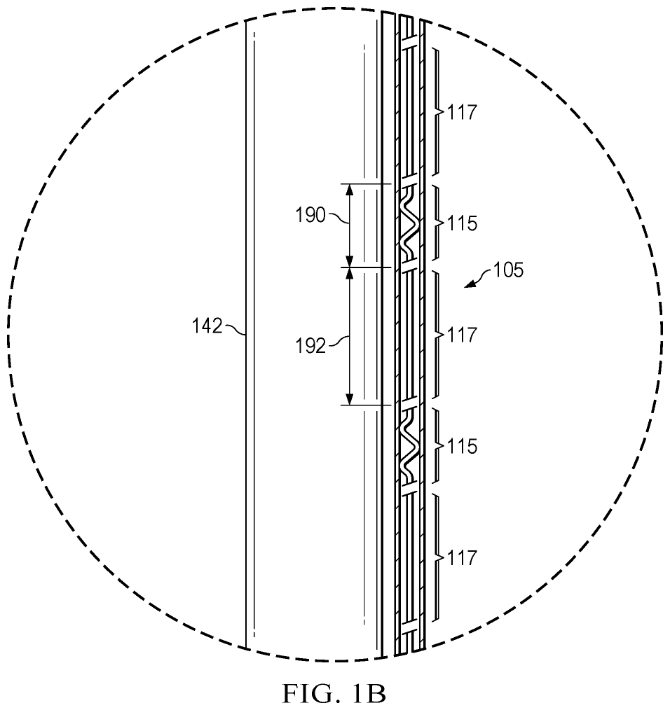

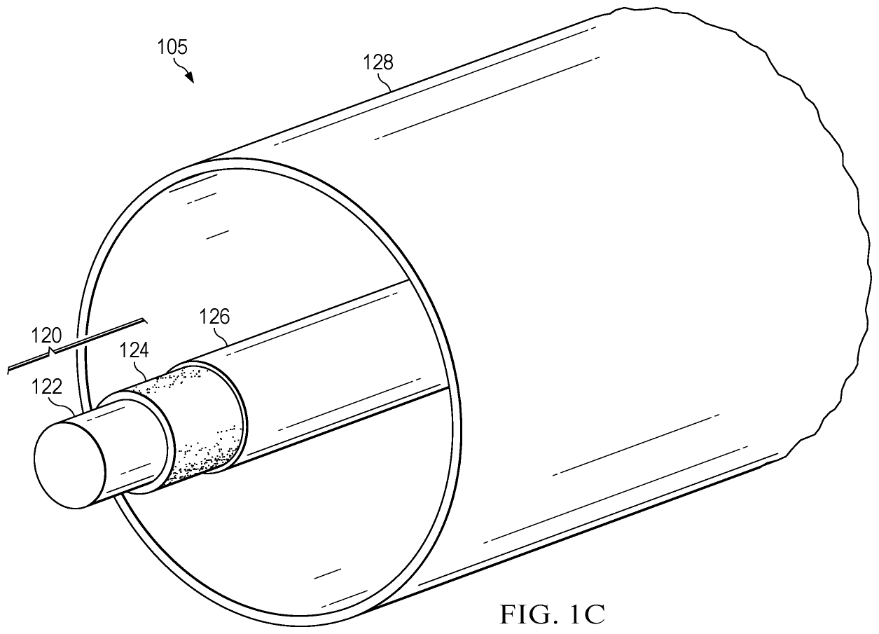

FIG. 1A presents a schematic view of an example embodiment of a well system including an electric cable connected to a downhole tool disposed in a wellbore of the system;

FIG. 1B presents a detailed view of a portion of an example embodiment of the electric cable of the disclosure;

FIG. 1C presents an exploded perspective view of portion an example embodiment of the electric cable of the disclosure;

FIG. 1D presents an exploded perspective view of another example embodiment of the electric cable of the disclosure;

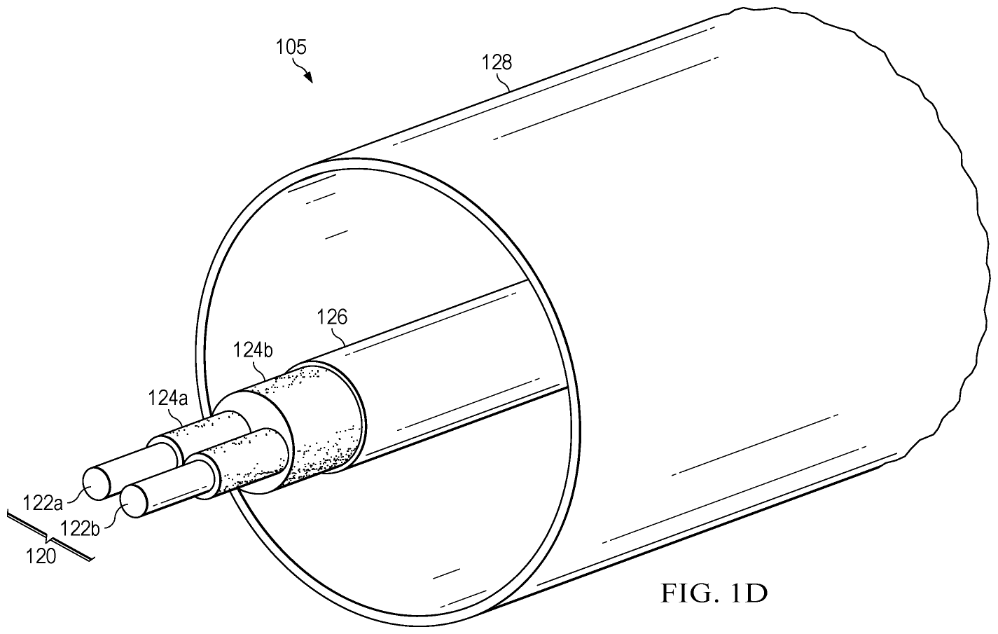

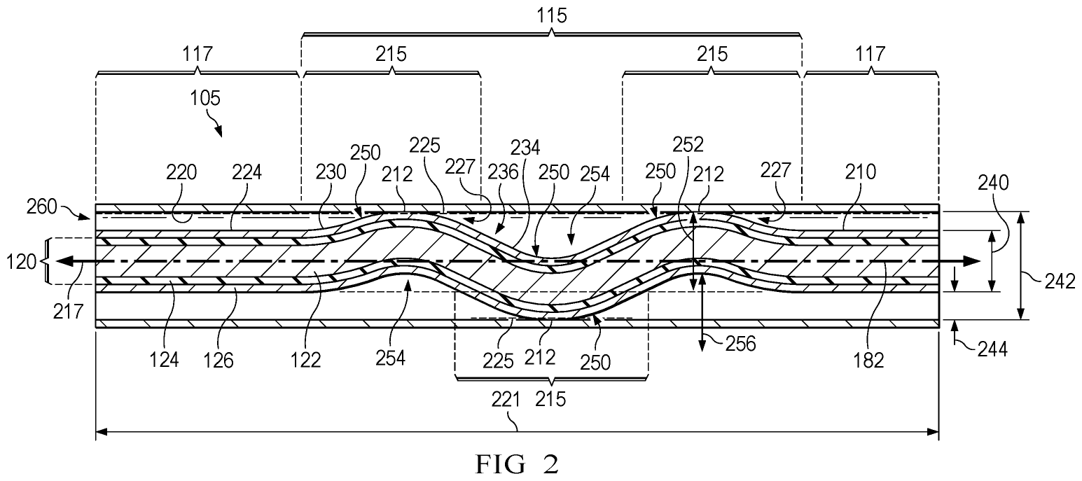

FIG. 2 presents a cross-sectional view of a portion of an example embodiment of the electric cable such as discussed in the context of FIGS. 1A-1D;

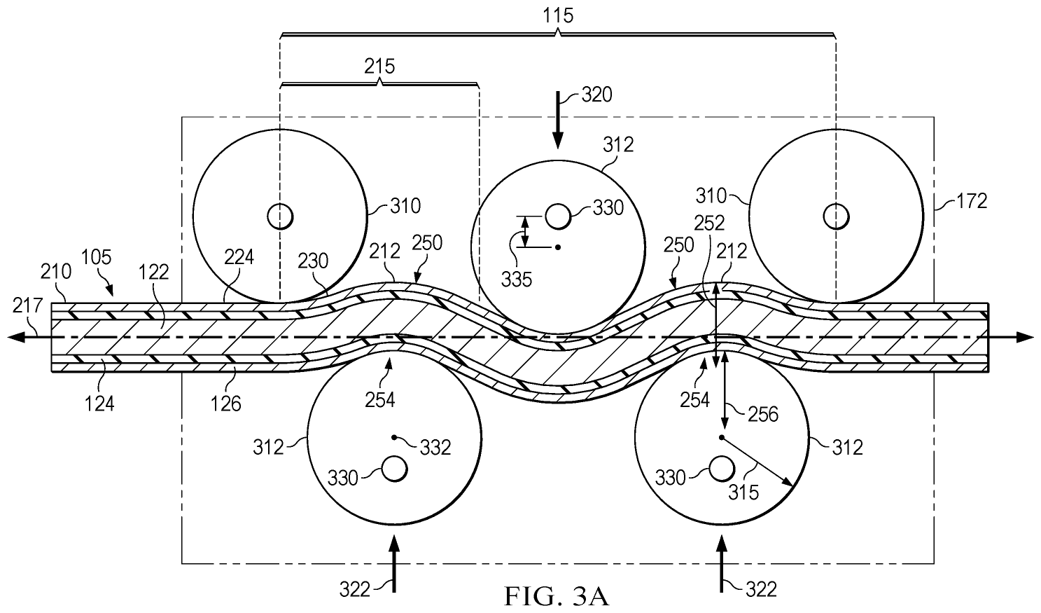

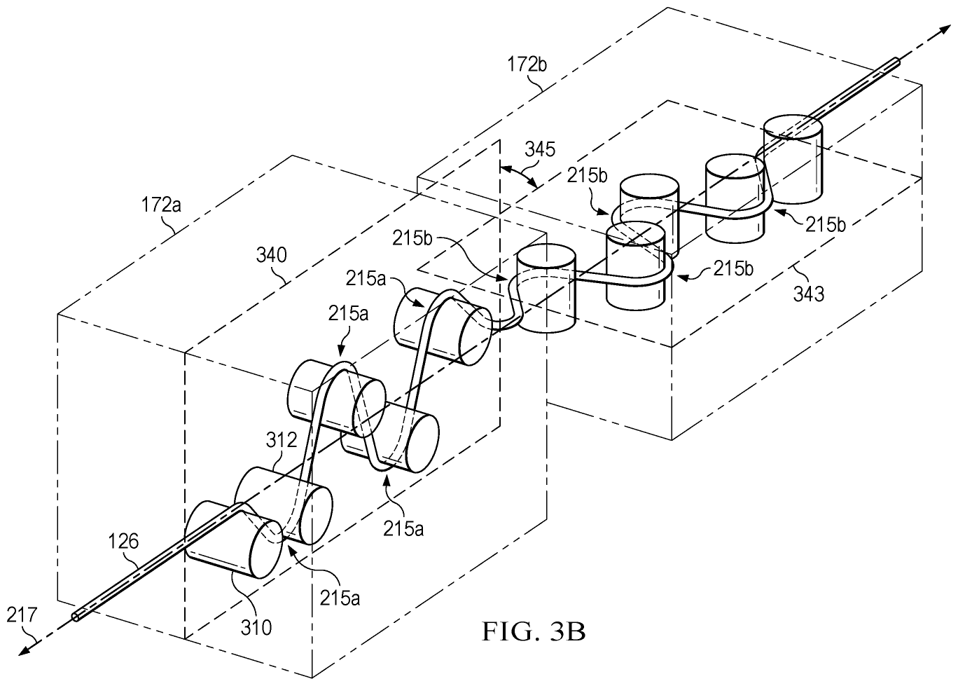

FIG. 3A presents a schematic cross-sectional view of an example bending machine for the production of undulated segments in the electric cable such as illustrated in FIG. 2;

FIG. 3B presents a schematic perspective view of another example bending machine for the production of undulated segments in the electric cable such as discussed in the context of FIGS. 2-3A; and

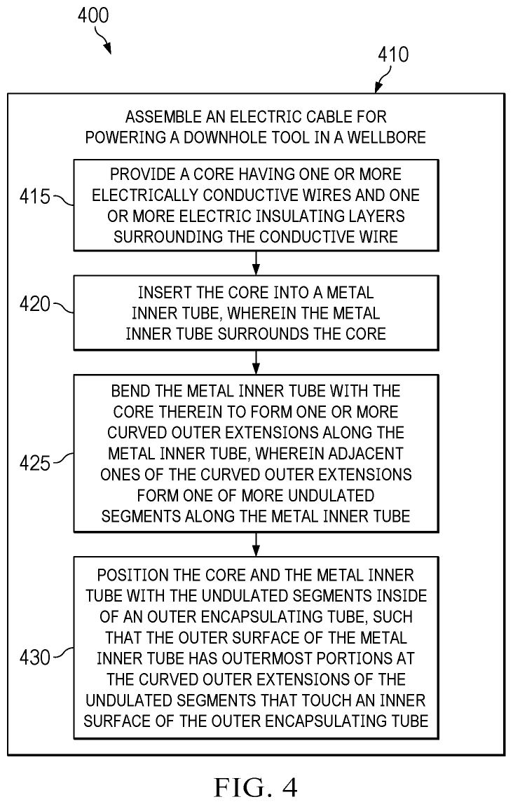

FIG. 4 presents a flow diagram of an example method of assembling any embodiments of the electric cable such as discussed in the context of FIGS. 1A-3B.

### DETAILED DESCRIPTION

Disclosed is an electric cable that includes undulated segments. The undulated segments help support the weight of the electric cable when the cable is vertically oriented in a wellbore to thereby take strain off of a splice or a connector of a downhole tool.

The use of an electrical cable having undulated segments provides advantages over cable dimpling or swaging procedure to provide weight support. For instance, dimpling can involve attaching anchors (e.g., cap screws) to the cable's core at regular intervals, inserting the core into a tube, and using an Eddy current detector to find the location of the anchors inside the tube. Then the tube is indented on either side of each anchor to produce sharp indentations or ‘dimples’ in the outer surface of the tube. Similarly, a swaging tool can be used to introduce a multiple sharp crimps into tubing to engage with the core. Such dimpling or swaging procedures are time consuming and laborious. The sharp indentations of the dimples or crimps introduce discontinuities in the outer surface of the tube which in turn, create localized stress points along the tube which can cause cracking, allowing fluid in the wellbore to contact and damage the core or contribute to the mechanical failure of the tube. Additionally, the specific placement of the anchors and the depths and locations of the dimples or crimps along the tube has to be precisely controlled to provide weight support but also avoid directly damaging the core.

In contrast to dimpling or swaging, the production undulated segments, as disclosed herein, can be anchor-free (e.g., dispensing with the need for placing anchors within a metal inner tube as disclosed herein), is simple to implement, allows the precise locations of the undulated segments to be readily identified, and bends of the undulated segments can be made smooth and continuous without introducing sharp indentations or discontinuities into the outer surface of the metal inner tube.

One embodiment of the disclosure is an electric cable for powering a downhole tool in a wellbore. FIG. 1A presents a schematic view of an example embodiment of a well system 100 including an electric cable 105 connected to a downhole tool 107 deployed in a wellbore 110 of the system.

FIG. 1B presents a detailed view of a portion of an embodiment of the electric cable 105 showing example undulated segments 115, and optional straight segments 117, of the cable 105.

FIG. 1C presents an exploded view of an example cable 105 showing a core 120 that includes one or more electrical conductive wires 122 (e.g., single strand solid aluminum or copper wires) wrapped in one or more electrical insulation layers 124 (e.g., one or more layers of ethylene propylene diene terpolymer, polyetherketone or similar non-conductive rubber or theromoplastic insulation), with the core 120 surrounded by a metal inner tube 126 (e.g., lead or similar thin metal tubing) and the core and the metal inner tube surrounded by an outer encapsulating tube 128 (e.g., lead or similar metal tubing) to further protect the one or more metal inner tubes 126 of the cable 105.

FIG. 1D presents an exploded view of an example cable 105 showing a core 120 that includes first and second electrical conductive wires 122a, 122b (e.g., each single strand solid aluminum or copper wire) each wire individually wrapped in a first electrical insulation layer 124a (e.g., ethylene propylene diene terpolymer, polyetherketone or similar non-conductive rubber or theromoplastic insulation), and both wrapped in a second electrical insulation layer 124b, and with the core 120 surrounded by a metal inner tube 126 (e.g., lead or similar thin metal tubing) and the core and the metal inner tube surrounded by an outer encapsulating tube 128.

Embodiments of the electric cable 105 can include a core 120 with one or more electrical conductive wires 122 and one or more electric insulating layers 124 surrounding the conductive wires. E.g., in an embodiment of the cable such as shown in FIG. 1C, the one electrical conductive wire 122 can carry a single phase of electric power (e.g., a voltage of a first phase) and another one electrical conductive wire 122, of a second different cable (not shown but analogous to cable 105 in FIG. 1C) to provide another single-phase power (e.g., a voltage of a second phase). E.g., in an embodiment of the cable, such as show in FIG. 1D, the first and second electrical conductive wire 122s, 122b can carry two different phases of electrical power. Based upon the present disclosure one skilled in the pertinent art would understand how embodiments of the cable could include a third, fourth etc. electrical conductive wire, to facilitate providing multi-phase power.

As illustrated in FIG. 1A, the wellbore 110 as shown, can be substantially vertically aligned near the well surface 130 with a trajectory downhole that continues vertically or becomes slanted or horizontal. The wellbore 110 can be cased with a casing 132 and can be cemented, or the wellbore can be an uncased open hole (e.g., a hole in the process of being drilled).

Some embodiments of the downhole tool 107 can be embodied as an electric submersible pump assembly (ESP) tool. Such an ESP tool 107 can include an electric motor 134, a seal unit 136 coupled to the electric motor 134, an inlet 138 coupled to the seal unit 136, and a pump 140 coupled to the inlet 138. The outlet of the pump 140 can be coupled to a production tube 142. The electric cable 105 can be connected to the electric motor 134 and extend along the downhole tool 107, along side the production tubing 142, to the surface 130, and connected to an electric power source (not show) located at the surface 130.

The downhole tool 107, when embodied as an ESP tool and powered by electricity provided through the cable 105 to the motor 134, can lift production fluid 150 via the pump 140 to the surface 130, the fluid 150 exiting a subterranean formation 152 into the wellbore 110 by flowing through the perforations 154 of the wellbore 110. The fluid 150 can enter the inlet 138 and be lifted to the surface 130 by the pump 140 via the production tubing 142 (e.g., coiled tubing).

As illustrated in FIG. 1A, the electric cable 105, the downhole tool 107 and the production tubing can be supported and vertically deployed in the wellbore 110 by a mast 160 of the system 100, e.g., by a block and tackle hoist of the mast 160. As the downhole tool 107 and production tubing 142 are assembled and deployed from the surface 130, the electric cable 105 can be rolled off of a cable spool 162 of the system 100. The electric cable 105 can be coupled to a connector 164 (e.g., a pothead connector in some embodiments) of the downhole tool 107 to secure the cable to a lead 166 of the downhole tool 107 (e.g., a motor lead 166 of the electric motor 134 of the ESP tool 107 in some embodiments) prior to deployment of the cable 105 and tool 107 into the wellbore 110.

The well system 100 embodiment depicted in FIG. 1A show features of a well completion system where the electric cable 105 powers a downhole tool 107 that includes or is an ESP. However, in other embodiments, the well system 100 can be a well drilling system. In such well drilling system embodiments, the production tubing can be replaced by a drilling string and the mast 160 can provide support for the drilling string 142 and cable 105. In such embodiments, the downhole tool 107 can be or include an electrically powered drilling tool (e.g., a pulse drilling tool) and the drilling tool would not include the seal unit 136, inlet 138 or pump 140. The electric cable 105 can connect to the drilling tool connector 164 to supply the electrical power. In such embodiments the cable can be connected to an electric power source and also a drilling head (not show) located at the surface 130. One or more undulated segments 115 can suspend the core 120 and inner metal tube 126 within the outer encapsulating tube 128 while, e.g., drilling mud is pumped down to the drill.

In still other embodiments, the downhole tool 107 can be or include an electrically powered testing tool for subterranean formation testing (e.g., a measurement-while-drilling tool, a logging-while-drilling tools or a wireline tool). Or, in other embodiments, the electric cable 105 can be connected to provide electrical power to an electric motor to actuate a subterranean formation sampling device, or to power sensors or data storage media of the testing tool, as familiar to those skilled in the pertinent arts.

With continuing reference to FIGS. 1A-1D, FIG. 2 presents a cross-section view of an embodiment of the electric cable 105 for powering a downhole tool 107 in a wellbore 110. The electric cable includes a core 120 including one or more electrically conductive wires 122 and one or more electric insulating layers 124 surrounding the conductive wires. The electric cable includes a metal inner tube 126 surrounding the core. The metal inner tubing and the core includes one or more undulated segments 115 with one or more curved outer extensions 215 projecting outwards from a longitudinal axis 217 of the electric cable. The electric cable also includes an outer encapsulating tube 128 surrounding the core and metal inner tube. The outer surface 210 of the metal inner tube has outermost portions 212 at the curved outer extensions 215 of the undulated segment that touch an inner surface 220 of the outer encapsulating tube.

By touching, frictional interference is produced between the outermost portions 212 of the outer surface 210 of the metal inner tube and the inner surface 220 of the outer encapsulating tube. The frictional interference, in turn, helps support the core 120 and metal inner tube 126 in place in the outer encapsulating tube 128 when the electric cable is vertically oriented in the wellbore, e.g., oriented such that the longitudinal axis 217 of the cable is substantially parallel (e.g., ±10 degrees) to a long axis of the wellbore 110 (e.g., long axis 182, FIG. 1A and FIG. 2).

As used herein, the term curved outer extensions 215 refers to those portions 212 of the metal inner tube's outer surface 210 that extend outwards (e.g., perpendicularly outwards) from a longitudinal axis 217 of the cable to touch the outer encapsulating tube's inner surface 220.

In some embodiments, the undulated segment 115 can be a single continuous segment extending over the full length of the cable (e.g., 90, 95 or 99 percent of the cable's length along length dimension 221). In other embodiments, the core 120 metal inner tube 126 can further include one or more straight segments 117. For instance, in some embodiments where the electric cable includes a plurality of the undulated segments 115, each of the undulated segments 115 can be separated from each other by straight segments 117 such that two nearest ones of the undulated segments are separated from each other by one of the straight segments. As non-limiting examples, in some embodiments, a 1 to 3 foot (0.3 to 0.8 m) length 190 of an undulated segment 115 can be separated from a nearest undulated segment by a 30 to 300 foot (9.1 to 91.4 m) length 192 of a straight segment 117.

In some such embodiments where the cable 105 includes straight segments 117, the one or more curved outer extensions 215 extend beyond surface portions 224 of the one or more straight segments 117. As non-limiting examples, in some embodiments, the curved outer extensions 215 extend beyond the surface portions 224 of the straight segments 117, e.g., in some embodiments extending at least 0.25 inches (0.05 m) beyond the straight segment's surface portions 224.

As illustrated in FIG. 2, for some embodiments of the electric cable, the outermost portions 212 of the outer surface 210 of the metal inner tube 126 that touch the inner surface 220 of the outer encapsulating tube 128 have tangent lines 225 that are substantially parallel (e.g., an acute angle 227 of 2 degrees or less) with respect to the inner surface 220 of the outer encapsulating tube 128. As further illustrated surface portions 230 of the curved outer extensions 215 of the metal inner tube 126 that do not touch the metal the inner surface 220 of the outer encapsulating tube 128 have tangent lines (e.g., tangent line 234 that are substantially non-parallel (e.g., acute angles 236 of greater than 2 degrees) with respect to the longitudinal axis 217 or with respect to an outer surface portion 224 of the optional straight segments 117 of the metal inner tube 126.

When the electric cable is vertically oriented in the wellbore, the outer surface portions 224 of the optional straight segments 117 do not touch the inner surface 220 of the outer encapsulating tube 128 because the outer diameter 240 of the metal inner tube 126 is less than the inner diameter 242 the outer encapsulating tube. As non-limiting example embodiments, the metal inner tube's outer diameter 240 can be a value in a range of 0.375 inches 2 inches (0.00925 to 0.051 m) and the outer encapsulating tube's inner diameter 242 can be a value in a range from 1 to 6 inches (0.0254 to 0.154 m) and therefore have an inner-to-outer surface gap 244 value in a range from 0.6 to 4 inches (0.015 to 0.102 m). In some embodiments, a ratio of the outer encapsulating tube's inner diameter 242 to the metal inner tube's outer diameter 240 can be a value of 1.5:1, 2:1, 2,5:1, 3:1, 3.5:1, 4:1 or values there-between. Based on the present disclosure, one skilled in the pertinent arts would understand that the metal inner tube's outer diameter could be any number of sizes (e.g., ⅜″, ½″, ¾″, 1″, 1.5″ etc.) and the outer encapsulating tube's inner diameter size adjusted accordingly.

FIG. 3A presents a schematic view of an example bending machine 172 (FIG. 1A) for the production of undulated segments 115 in the electric cable 105 such as illustrated in FIG. 2. Only the core 120 and inner metal tube 126 are depicted, e.g., prior to their positioning inside of the outer encapsulating tube 128.

With continuing reference to FIGS. 2-3A, embodiments of the electric cable can assembled with the aid of a bending machine 172 equipped with circular rollers (e.g., rollers 310, 312) to facilitate the forming of the curved outer extensions 215 of the undulated segments 115, such that the outer surface 210 of the metal inner tube in the curved outer extensions 215 are smooth and free of discontinuities.

As used herein, the term, smooth and free of discontinuities, means that there are no abrupt visible changes in the tubing's surface, e.g., such as produced by dimpling or crimping (e.g., no 70 degree or higher degree bend angle over a 1 inch or less length (e.g., along the length dimension 221 of the metal inner tube 126).

As illustrated in FIGS. 2 and 3A, a side portion 250 (or portions) of the metal inner tube 126 having the curved outer extension 215 (or extensions) have an inner bend radius 252. As non-limiting examples, in some such embodiments of the cable, the inner bend radius 252 is a value in a range from 1 to 10 inches (0.025 to 0.25 m). As further illustrated, and continuing with the same example, a side portion 254 of the metal inner tube 126 directly opposite to the side portion 250 with the curved outer extension 215 has an outer bend radius 256 that is substantially equal to (e.g., ±10%) the inner bend radius 252 (e.g., an outer bend radius 256 value in a range from 1 to 10 inches).

As also illustrated, the curved outer extensions 215 of the metal inner tube 126 can all be in a same first plane perpendicular to a longitudinal axis 217 of the electric cable 105, e.g., the plane of the page depicted in FIGS. 2 and 3A. For instance, the curved outer extensions 215 can all be formed in a same first plane, e.g., as formed by rollers 310, 312 of the bending machine 172. For instance, the bending machine 172 can include centered rollers 310 which are fixed in place and driving rollers 312 which are moved in directions (e.g., directions 320 322) towards the metal inner tube 126 to apply a force (a bending force) on the tubing to form the curved outer extensions 215 of the undulated segments 115. Thus, in such embodiments, the inner bend radius 252 and the outer bend radius 256 can be defined by a central radius 315 of the rollers 310, 312 of the bending machine 172.

As further illustrated, in some embodiments, one or more of the axials 330 of the driving rollers 312 can be offset from the centers of the rollers (e.g., center 332) to facilitate movement of the rollers 312 via a camshaft mechanism along the directions 320, 322 towards and away from the metal inner tube 126. As non-limiting examples, in some embodiments, the axials 330 of the driving rollers 312 can be offset by an offset distance 335 that is 10, 20, 30, 40, 50, 60 or 70 percent of the central radius 315.

FIG. 3B presents a perspective view of another example bending machine (e.g., first bending machine module 172a and a second bending machine module 172b) for the production of undulated segments in the electric cable. Some of the curved outer extensions (e.g., extensions 215a) of the metal inner tubing are in a first plane (e.g., plane 340) that is perpendicular to a longitudinal axis 217 of the electric cable and other curved outer extensions (e.g., extensions 215b) are in a second plane (e.g., plane 342) perpendicular to the longitudinal axis and at an off-set angle (e.g., off-set angle 345) from the first plane. In some such embodiments, as illustrated in FIG. 3B, the off-set angle 345 can be 90 degrees, e.g., other curved outer extensions (e.g., extensions 215b) are in the second plane 340 which is perpendicular to the longitudinal axis 217 and the second plane 342 is perpendicular to the first plane 340.

Based on the present disclosure, one skilled in the pertinent art would appreciate how the bending machine modules 172a, 172b could be rotationally oriented relative to each other to adjust to off-set angle 345 to any desired non-zero value, e.g., 45, 90, 135, 180, 225, 270 degrees.

Based on the present disclosure, one skilled in the pertinent art would appreciate how the radius 315 of the individual rollers 310, 312 of the bending machine 172 (or machine modules 172a, 172b), the number of rollers, and the spacing between rollers, could be set to different values so as to form a variety curved outer extension structures for each undulated segment of the electric cable, e.g., as needed to provide suspension support for the cable when vertically orientated.

With continuing reference to FIGS. 1A-3B, another embodiment of the disclosure is a well system 100 that includes a downhole tool 107 electric cable 105 connected to the downhole tool 107 in a wellbore 110. The electric cable 105 and downhole tool 107 can be or include any of the embodiments disclosed herein. The electric cable 105 includes the core 120, metal inner tube 126, with one or more undulated segments 115 and an outer encapsulating tube 128 surrounding the core and metal inner tube, the outer surface 210 of the metal inner tube having outermost portions 212 at the curved outer extensions 215 of the undulated segments that touch an inner surface 220 of the outer encapsulating tube. As non-limiting examples, the downhole tool 107 can be an electric submersible pump assembly tool for a well system 100 that is a well completion system, or, the downhole tool can be a drilling tool, a sampling tool or a testing tool for a well system that is a well drilling system.

Splices (e.g., spices 170a, 1700b) of the system 100 can be used to connect various lengths of electric cable 105 together to extend the to the desire depth to which the downhole tool 107 is deployed. As non-limiting examples, three separate lengths of the electric cable 105, each 5000 or 8000 feet long, can be spliced together to provide a total length of 15000 or 24000 feet, respectively. Any one or all of such spliced electric cables 105 can include one or more of the undulated segments 115.

In some embodiments, the system 100 includes a bending machine. In such embodiments, the bending machine (e.g., any embodiments of the machines 172, 172a, 172b discussed in the context of FIGS. 3A-3B), located on-site, can be arranged to form the undulated segments 115 in the electric cable 105. E.g., the undulated segments can be formed in the cable as the cable is reeled off on the cable spool 162. Alternatively, the undulated segments can be formed in the cable at an off-site location, and then reeled onto spools 182 which are then transported on-site to be deployed in the system 100.

In some embodiments, the system 100 includes a swaging machine 174 to place the core 120 and the metal inner tube 126, with the undulated segments 115 formed therein, into the outer encapsulating tube. In some such embodiments, the swaging machine, located on-site, can be used to place the outer encapsulating tube 128 around the core 120 and the metal inner tube 126 after the undulated segments 115 are formed in the cable 105. E.g., portions of the cable, including the undulated segments, can be transferred from the bending machine 172 onto a metal layer 176 as the swaging machine 174 is forming the metal layer into the outer encapsulating tube 128. Alternatively, a preformed outer encapsulating tube 128 can be transported on-site to the system 100 and the core 120 and inner metal tube 126, including undulated segments 115, can be placed, moving the core 120 and inner metal tube 126 (e.g., by being pulled or pushed), into the outer encapsulating tube 128, e.g., after the undulated segments 115 is formed either on-site or off-site.

In some embodiments, the cable 105 can be secured to the production tubing or drilling string 142 with a one or more securing elements 180 of the system 100 (e.g., clamps, brackets, or bands), e.g., coupled to the outer encapsulating tube 128, as familiar to those skilled in the pertinent arts.

Another embodiment of the disclosure is a method of manufacturing an electric cable for connection to a downhole tool disposed in a wellbore of a well system. FIG. 4 presents a flow diagram of an example method 400 of manufacturing any embodiments of the electric cable 105 discussed in the context of FIGS. 1A-3B. With continuing reference to FIGS. 1A-3B, the method 400 includes assembling (step 410) a formation sampling probe for subterranean formation testing within a borehole of a well site.

The assembling (step 410) includes providing 415 a core 120 having one or more electrically conductive wire 122 and one or more electric insulating layers 124 surrounding the electrically conductive wire and inserting (step 420) the core into a metal inner tube 126 such that the metal inner tube surrounds the core 120.

Assembling (step 410) includes bending (step 425) the metal inner tube 126 and the core 120 therein to form one or more curved outer extensions 215 along the metal inner tube, wherein adjacent ones of the curved outer extensions 215 form one of more undulated segments 115 along the metal inner tube. In some such embodiments, the bending step 425 includes placing a portion of the metal inner tube 126 with the core 120 therein between rollers 310, 312 of a bending machine (e.g., any of machines 172, 172a, 172b) and moving at least some of the rollers (e.g., drive rollers 312) in directions (e.g., directions 320, 322) towards the metal inner tube 126 to apply a bending force to the metal inner tube 126 to form the curved outer extensions 215 of the undulated segments.

Assembling (step 410) includes positioning (step 430) the core 120 and the metal inner tube 126 with the undulated segments 115 inside of an outer encapsulating tube 128 such that the outer surface 210 of the metal inner tube has outermost portions 212 at the curved outer extensions 215 of the undulated segments that touch an inner surface 220 of the outer encapsulating tube. In some embodiments, the positioning step 430 includes placing a portion of the metal inner tube 126 with the core 120 therein and the undulated segments there-along, on a metal layer 176 located on a swaging machine 174 and forming the metal layer into the outer encapsulating tube 128 such that the metal inner tube 126 and the core 120 are inside of the outer encapsulating tube 128. In some embodiments, the positioning step 430 includes moving (e.g., pushing or pulling) the metal inner tube 126, with the core 120 therein and the undulated segments there-along, though an end-opening (e.g., end-opening 260, FIG. 2) of the outer encapsulating tube 128.

Each of the foregoing embodiments may include one or more of the following elements singly or in combination, and neither the example embodiments or the following listed elements limit the disclosure, but are provided as examples of the various embodiments covered by the disclosure:

Element 1: An electric cable for powering a downhole tool in a wellbore, the electric cable comprising: a core including one or more electrically conductive wires and one or more electric insulating layers surrounding the conductive wires; a metal inner tube surrounding the core, wherein the metal inner tubing and the core includes one or more undulated segments with one or more curved outer extensions projecting outwards from a longitudinal axis of the electric cable; and an outer encapsulating tube surrounding the core and metal inner tube, wherein the outer surface of the metal inner tube has outermost portions at the curved outer extensions of the undulated segments that touch an inner surface of the outer encapsulating tube.

Element 2: the electric cable wherein the metal inner tubing and the core further includes one or more straight segments.

Element 3: the electric cable wherein two nearest ones of the undulated segments are separated from each other by one of the straight segments.

Element 4: the electric cable wherein the one or more curved outer extensions extend beyond surface portions of the one or more straight segments.

Element 5: the electric cable wherein the outermost portions of the outer surface of the metal inner tube that touch the inner surface of the outer encapsulating tube have tangent lines that are substantially parallel with respect to the inner surface of the outer encapsulating tube.

Element 6: the electric cable wherein the curved outer extensions of the metal inner tube that do not touch the metal the inner surface of the outer encapsulating tube have tangent lines that are substantially non-parallel with respect to the longitudinal axis or to surface portions of straight segments of the metal inner tube.

Element 7: the electric cable wherein the outer surface of the metal inner tube in the curved outer extensions are smooth and free of discontinuities.

Element 8: the electric cable wherein a side portion of the metal inner tube having the curved outer extension has a outer bend radius value in a range from 1 to 10 inches.

Element 9: the electric cable wherein a side portion of the metal inner tube directly opposite the side portion having the curved outer extension has an inner bend radius that is substantially equal to the outer bend radius.

Element 10: the electric cable wherein the curved outer extensions of the metal inner tubing are in a same first plane perpendicular to a longitudinal axis of the electric cable.

Element 11: the electric cable wherein some of the curved outer extensions of the metal inner tube are in the first plane perpendicular to a longitudinal axis of the electric cable and others of the curved outer extensions are in a second plane perpendicular to the long axis and at an off-set angle from the first plane.

Element 12: A well system comprising a downhole tool and an electric cable connected to the downhole tool in a wellbore, wherein the electric cable includes: a core including one or more electrically conductive wires and one or more electric insulating layers surrounding the conductive wires; a metal inner tube surrounding the core, wherein the metal inner tube and the core includes one or more undulated segments with one or more curved outer extensions projecting outwards from a longitudinal axis of the electric cable; and an outer encapsulating tube surrounding the core and metal inner tube, wherein the outer surface of the metal inner tube has outermost portions at the curved outer extensions of the undulated segments that touch an inner surface of the outer encapsulating tube.

Element 13: the system wherein the downhole tool is an electric submersible pump assembly tool for a well system that is a well completion system.

Element 14: the system wherein the downhole tool is a drilling tool, a sampling tool or a testing tool for a well system that is a well drilling system.

Element 15: the system further including a bending machine to form the undulated segments in the cable.

Element 16: the system further including a swaging machine to place the core and the metal tubing, with the undulated segments formed therein, into the outer encapsulating tube.

Element 17: a method, comprising: assembling an electric cable for powering a downhole tool in a wellbore, including providing a core having one or more electrically conductive wires and one or more electric insulating layers surrounding the electrically conductive wire; inserting the core into a metal inner tube, wherein the metal inner tube surrounds the core; bending the metal inner tube and the core therein to form one or more curved outer extensions along the metal inner tube, wherein adjacent ones of the curved outer extensions form one of more undulated segments along the metal inner tube; and positioning the core and the metal tube with the undulated segments inside of an outer encapsulating tube such that the outer surface of the metal inner tube has outermost portions at the curved outer extensions of the undulated segments that touch an inner surface of the outer encapsulating tube.

Element 18: the method wherein the bending includes placing a portion of the metal inner tube with the core therein between rollers of a bending machine and moving at least some of the rollers towards the metal inner tube to apply a bending force thereto to form the curved outer extensions of the undulated segments.

Element 19: the method wherein the bending includes placing a portion of the metal inner tube with the core therein between rollers of a bending machine and moving at least some of the rollers towards the metal inner tube to apply a bending force thereto to form the curved outer extensions of the undulated segments.

Element 20: the method wherein the positioning 430 includes moving the metal inner tube 126, with the core 120 therein and the undulated segments there-along, though an end-opening 260 of the outer encapsulating tube 128.

The foregoing listed embodiments and elements do not limit the disclosure to just those listed above, and those skilled in the art to which this application relates will appreciate that other and further additions, deletions, substitutions and modifications may be made to the described embodiments.

What is claimed is:

1. An electric cable for powering a downhole tool in a wellbore, the electric cable comprising:
a core including one or more electrically conductive wires and one or more electric insulating layers surrounding the conductive wires;
a metal inner tube surrounding the core, wherein the metal inner tubing and the core includes one or more undulated segments with one or more curved outer extensions projecting outwards from a longitudinal axis of the electric cable; and
an outer encapsulating tube surrounding the core and metal inner tube, wherein the outer surface of the metal inner tube has outermost portions at the curved outer extensions of the undulated segments that touch an inner surface of the outer encapsulating tube.

2. The electric cable of claim 1, wherein the metal inner tubing and the core further include one or more straight segments.

3. The electric cable of claim 2 wherein two nearest ones of the undulated segments are separated from each other by one of the straight segments.

4. The electric cable of claim 2, wherein the one or more curved outer extensions extend beyond the surface portions of the one or more straight segments.

5. The electric cable of claim 1, wherein the outermost portions of the outer surface of the metal inner tube that touch the inner surface of the outer encapsulating tube have tangent lines that are substantially parallel with respect to the inner surface of the outer encapsulating tube.

6. The electric cable of claim 1, wherein the curved outer extensions of the metal inner tube that do not touch the metal the inner surface of the outer encapsulating tube have tangent lines that are substantially non-parallel with respect to the longitudinal axis or to an surface portions of straight segments of the metal inner tube.

7. The electric cable of claim 1, wherein the outer surface of the metal inner tube in the curved outer extensions are smooth and free of discontinuities.

8. The electric cable of claim 1, wherein a side portion of the metal inner tube having the curved outer extension has an outer bend radius value in a range from 1 to 10 inches.

9. The electric cable of claim 8, wherein a side portion of the metal inner tube directly opposite the side portion having the curved outer extension has an inner bend radius that is substantially equal to the outer bend radius.

10. The electric cable of claim 1, wherein the curved outer extensions of the metal inner tubing are in a same first plane perpendicular to a longitudinal axis of the electric cable.

11. The electric cable of claim 1, wherein some of the curved outer extensions of the metal inner tube are in the first plane perpendicular to a longitudinal axis of the electric cable and others of the curved outer extensions are in a second plane perpendicular to the long axis and at an off-set angle from the first plane.

12. A well system, comprising:
a downhole tool;
an electric cable connected to the downhole tool, wherein the electric cable includes:
a core including one or more electrically conductive wires and one or more electric insulating layers surrounding the conductive wires;
a metal inner tube surrounding the core, wherein the metal inner tubing and the core includes one or more undulated segments with one or more curved outer extensions projecting outwards from a longitudinal axis of the electric cable; and
an outer encapsulating tube surrounding the core and metal inner tube, wherein the outer surface of the metal inner tube has outermost portions at the curved outer extensions of the undulated segments that touch an inner surface of the outer encapsulating tube.

13. The system of claim 12, wherein the downhole tool is an electric submersible pump assembly tool for a well system that is a well completion system.

14. The system of claim 12, wherein the downhole tool is a drilling tool, a sampling tool or a testing for a well system that is a well drilling system.

15. The system of claim 12, further including a bending machine to form the undulated segments in the cable.

16. The system of claim 12, further including a swaging machine to place the core and the metal tubing, with the undulated segments formed therein, into the outer encapsulating tube.

17. A method, comprising:
assembling an electric cable for powering a downhole tool in a wellbore, including:
providing a core having one or more electrically conductive wires and one or more electric insulating layers surrounding the electrically conductive wires;
inserting the core into a metal inner tube, wherein the metal inner tube surrounds the core;
bending the metal inner tubing and the core therein to form one or more curved outer extensions along the metal inner tube, wherein adjacent ones of the curved outer extensions form one of more undulated segments along the metal inner tube; and
positioning the core and the metal tube with the undulated segments inside of an outer encapsulating tube such that the outer surface of the metal inner tube has outermost portions at the curved outer extensions of the undulated segments that touch an inner surface of the outer encapsulating tube.

18. The method of claim 17, wherein the bending includes placing a portion of the metal inner tube with the core therein between rollers of a bending machine and moving at least some of the rollers towards the metal inner tube to apply a bending force thereto to form the curved outer extensions of the undulated segments.

19. The method of claim 17, wherein the positioning includes placing a portion of the metal inner tube with the core therein and the undulated segments there-along, on a metal layer located on a swaging machine and forming the metal layer into the outer encapsulating tube such that the metal inner tube and the core are inside of the outer encapsulating tube.

20. The method of claim 17, wherein the positioning includes moving the metal inner tube, with the core therein and the undulated segments there-along, though an end-opening of the outer encapsulating tube.
